(19) United States
(12) Patent Application Publication
(10) Pub. No.: US 2008/0090472 A1
(43) Pub. Date: Apr. 17, 2008

(54) 500 kcmil 2 Way Insulated Crab Joint with (2) #2 and (2) # 6 Service Pigtails

(76) Inventor: Alessandro Ferrara, Staten Island, NY (US)

Correspondence Address: Alessandro Ferrara, 81 Sunfield Ave, Staten Island, NY, 10312, US

(21) Appl. No.: 11/534,617

(22) Filed: Oct. 16, 2006

(51) Int. Cl. H01R 11/03

(52) U.S. Cl. 439/790

(57) ABSTRACT

The purpose of this invention is to connect electrical service wires from a main electrical feed 500 KCMIL cable to residential and commercial customers with #2 and #6 Service Cables.

It will also expedite the restoration of Electric Service to the customer, by eliminating multiple Crab Joints.

This Invention is for the use of Electric Distribution. The purpose of the

Two Way Insulated Crab Joint with Service Pigtails is to connect a 500 KCMIL Secondary Main to (2) #2 and (2) #6 Service Pigtails. The #2 and #6 Service Pigtails will be connected to Residential or Commercial Customers providing them with their electric service.

The 2 Way Insulated Crab Joint can accommodate up to (4) 500 KCMIL Mains (Wires).

This invention eliminates the use of a 500 KCMIL to (2) 4/0 cable size Insulated Connector, also eliminates a Crab Joint with Pigtails. It incorporates the Pigtails and the 500 KCMIL 2 Way Crab Joint as one. It also provides the means to connect several cables at one common junction. The 2 Way Insulated Crab Joint is made from pure copper, also tinplated to resist corrosion. It is insulated with EPDM rubber. Installation is done by rolling back the rubber insulation on the cable sockets; inserting the 500 KCMIL cable into the socket and crimping it. Then, the insulation is rolled back to it's original position providing the necessary insulation over the 500 KCMIL socket. The connections for the (2) #2 and (2) #6 Pigtails would be done by installing a #2 or #6 connector to the end of the Pigtails once the appropriate amount of the insulation is removed from the Pigtail wires. Once the connector is in place, it will be crimped and insulated via a heat shrink sleeve completing the service connection to the customer.

Enclosed, are three (3) drawings of the 500 KCMIL 2 Way Insulated Crab Joint with (2) #2 and (2) #6 Service Pigtails.

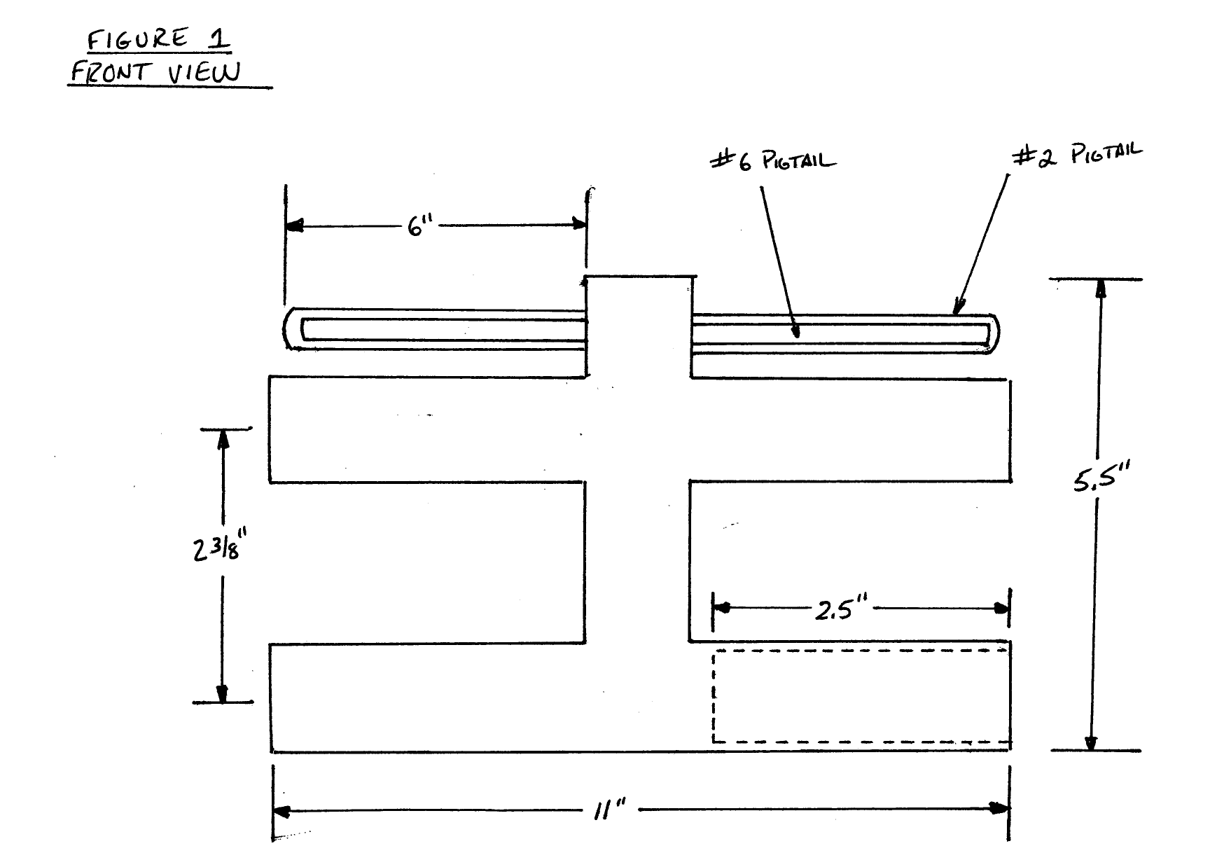

FIG. 1, is the front view of the 2 Way Insulated Crab Joint. This is the way the 2 Way Insulated Crab Joint would appear it is connected to the 500 KCMIL electric cable.

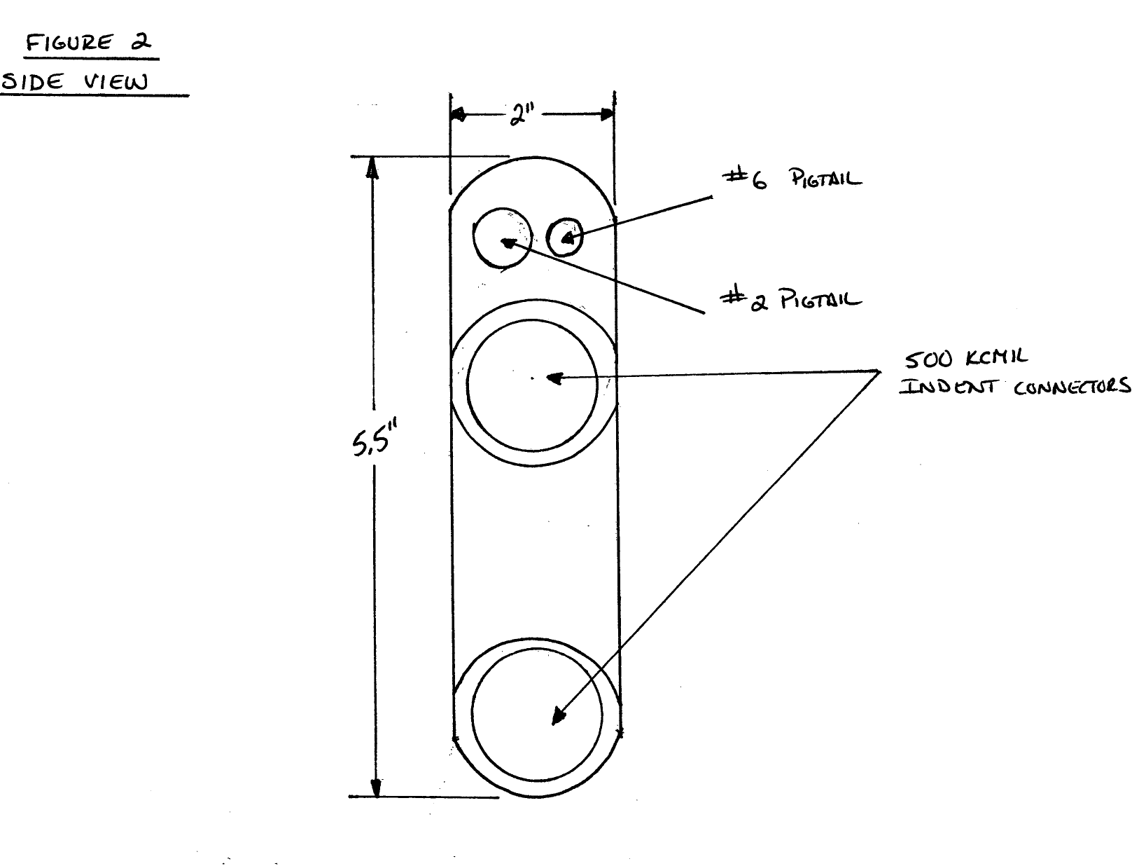

FIG. 2 shows the profile of the of the 2 Way Insulated Crab Joint where the 500 KCMIL electric cable would be connected, also shows the #2 and the #6 pigtails in which the customer service wires would be connected to.

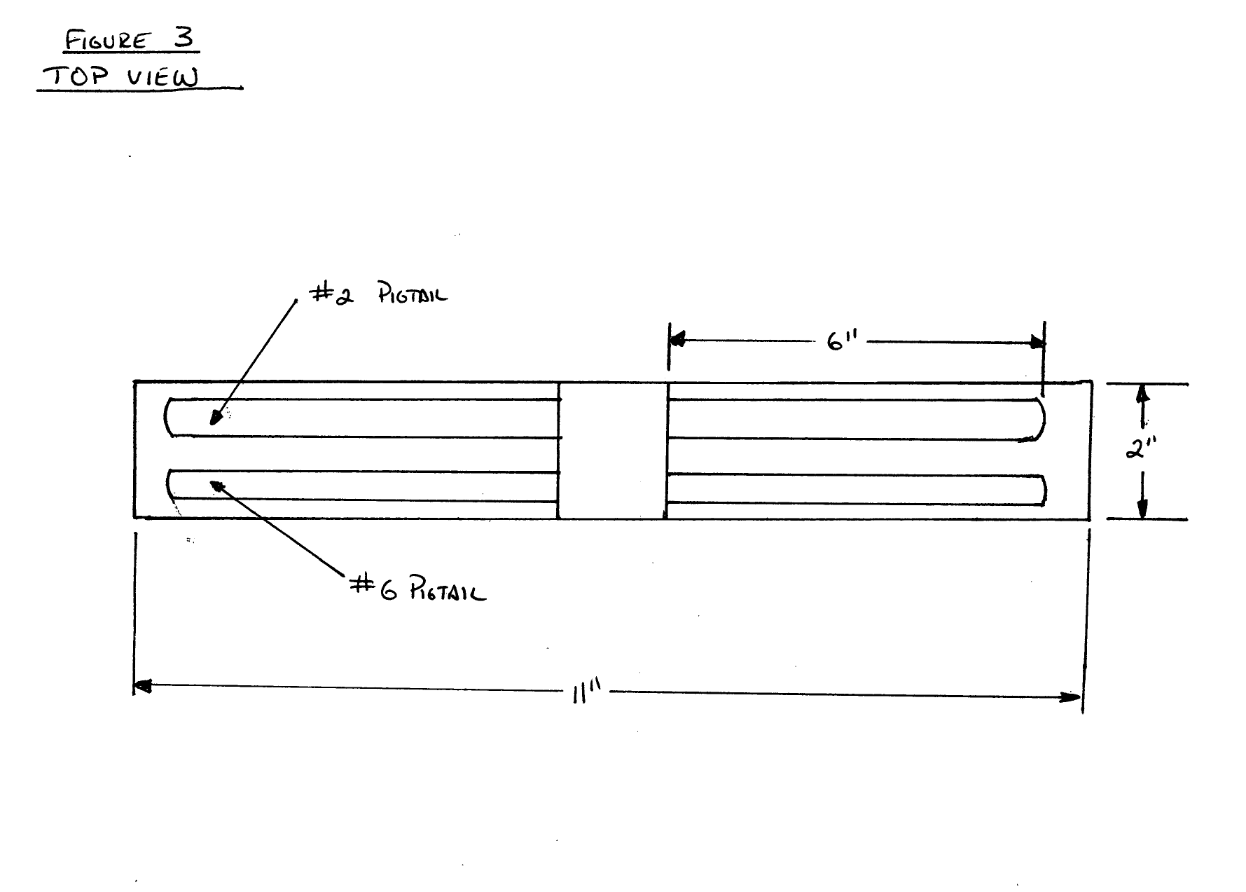

FIG. 3 shows the top view of the 2 Way Insulated Crab Joint. This is the view seen from the top of the manhole looking down into the structure containing the 2 Way Insulated Crab Joint and all the electric cables and services connected to it. It also shows the (2) #2 and (2) #6 Pigtails where the customer services would be connected to and below them is the 500 KCMIL socket in which the 500 KCMIL electric cable would be inserted and crimped.

1. I, Alessandro Ferrara claim that the invention named The 500 KCMIL 2 Way Insulated Crab Joint with (2) #2 and (2) #6 Service Pigtails to be a junction of various sizes of electrical connections to provide electric service to Utility Customers. The 2 Way Insulated Crab Joint with Service Pigtails will eliminate a 500 KCMIL to (2) 4/0 Insulated Crab Joint. It will also eliminate an Insulated Crab Joint with Pigtails. Thus, creating a one piece Crab Joint that will accommodate various size electrical wires all into one common junction. It will eliminate the need for a larger space to accommodate all three Insulated Crab Joints. This Crab Joint is to be used for Underground Electric Distribution by Electric Utilities.
